(19) United States
(12) Patent Application Publication
(10) Pub. No.: US 2015/0052486 A1
(43) Pub. Date: Feb. 19, 2015

(54) INTERFACE FOR MULTI-FUNCTIONAL COMMUNICATION DEVICES AND METHOD OF OPERATING

(71) Applicant: Naftali David GOODMAN, Efrat (IL)

(72) Inventor: Naftali David GOODMAN, Efrat (IL)

(21) Appl. No.: 14/331,344

(22) Filed: Jul. 15, 2014

Related U.S. Application Data
(60) Provisional application No. 61/865,213, filed on Aug. 13, 2013.

(51) Int. Cl. G06F 3/0481; G06F 3/0482; H04M 1/725; G06F 3/0488

(52) U.S. Cl. CPC G06F 3/04817; G06F 3/0488; G06F 3/0482; H04M 1/72583
USPC 715/835; 715/863

(57) ABSTRACT

A smart-phone interface including an arrangement of icons for opening applications arranged around perimeter of display screen leaving an empty central workspace, and a method of activating the smart-phone of consisting of touching the touch screen of the smart-phone with a finger having a fingerprint recognizable by the smart-phone and dragging the finger in a G shape.

### BACKGROUND

### Field of the Invention

The present invention is directed to an interface and operating system for a communication and web-browsing device having a graphical user interface (GUI), such as a smart phone, personal digital assistant, tablet or laptop computer. The interface is particularly appropriate for touch screens, but could be navigated with a cursor driven by a joystick, keys, mouse or tracker ball. Furthermore, voice activated navigation could be used, so the interface may be navigated by the physically impaired and may be useful for navigation by Google glasses. Since, discussion below will focus on smart phones.

A smart-phone, or smart phone, is a mobile phone built on a mobile operating system, but having more advanced computing capability and connectivity than a feature phone.

The first smart-phones combined the functions of a personal digital assistant (PDA) with a mobile phone. Later models added the functionality of portable media players, low-end compact digital cameras, pocket video cameras, and GPS navigation units to form one multi-use device. Many modern smart-phones also include high-resolution touch-screens and web browsers that display standard web pages as well as mobile-optimized sites. High-speed data access is provided by WiFi and mobile broadband. In recent years, the rapid development of mobile app markets and of mobile commerce have been drivers of smart-phone adoption.

The mobile operating systems (OS) used by modern smart-phones include Google's Android, Apple's iOS, Nokia's Symbian, RIM's BlackBerry OS, Samsung's Bada, Microsoft's Windows Phone, Hewlett-Packard's webOS, and embedded Linux distributions such as Maemo and MeeGo. Such operating systems can be installed on many different phone models, and typically each device can receive multiple OS software updates over its lifetime. A few other upcoming operating systems are Mozilla's Firefox OS, Canonical Ltd.'s Ubuntu Phone, and Tizen.

Worldwide sales of smart-phones overtook those of feature phones in early 2013.

Thus it will be appreciated that for the foreseeable future, most personal mobile telephones will be smart-phones, and the majority of these will include a touch screen, possibly to the exclusion of a regular pad of depressible keys.

Most smart phones with touch screens offer an array of icons corresponding to different applications (Apps) and functions, that the user may ‘open’, i.e. activate, by touching. The opened application generally fills the screen and allows the user to interact therewith, displaying information and often receiving inputs from the user.

There are applications that are packaged into the individual smart phone and these typically include a clock, calendar, contact list (telephone directory), display of recent callers, an instant messaging program, and the like. Often the smart-phone includes a media player which may be configured to play audio files and/or audio visual files. Typically the smart phone includes a camera and may also include a limited number of games bundled in. Some systems, such as the Apple i-phone enable the user to download applications from an Apple App store. Other smart-phones are more or less easily programmed.

A common application may include a navigation facility that uses GPS or the antenna array of the service provider for positioning and navigation. Generally, the standard most frequently used applications are displayed in an array over the screen and selecting an application opens it over the full or most of the screen, obscuring other icons.

Since smart phones enable access to personal information, including bank accounts, there is often a password that is required to allow interaction. In the Apple i-phone, a grid of points is shown and the operator is required to move his finger across a preconfigured array of points in a preconfigured order to unlock the phone and allow further interaction.

Most individual applications are stand-alone. It is possible to dial or send an email from the phone list, but diaries and calendars, the GPS, media player and other programs are separate entities. The smart phone is thus a mobile phone AND an internet browser AND a camera AND a navigation tool AND a personal media player AND a handheld video game device AND an e-reader (electronic book reader) all cohabiting the same package, but used separately.

Aspects of the present invention are directed at a smart phone and to a smart phone interface and offers improved usability and improvements on the current state of affairs.

### SUMMARY

A first aspect of the invention is directed to a smart-phone interface comprising an arrangement of icons for opening applications arranged around perimeter of display screen leaving an empty central workspace.

In one aspect, the icons are arranged logically.

Optionally, the arrangement has two foci, a first focus being occupation and a second focus being home.

In some embodiments, the first focus is positioned at a top of the screen and the second focus is positioned at a bottom of the screen.

Optionally, applications are configured to update each other as applicable.

The icons may be selected from the group comprising skeuomorphic icons, flat icons and simple geometric shapes.

In some embodiments, the icons are simple geometric shapes that are differentiated from each other by at least one of the group comprising size, shape or color.

In some embodiments, the icons are simple geometric shapes that are differentiated from each other by a label selected from the group comprising numbers, letters, words and symbols.

In some embodiments, the icons are geometric shapes selected from the group comprising circles, ellipses, squares, rectangles and rectangles with rounded corners.

Optionally, selection of at least one icon causes a display of a range of second level icons of a hierarchical structure, and selection of at least one of the second level icons causes display of third level icons.

Optionally, interaction with an application via selection of an icon updates icons of same level in the hierarchical structure.

Optionally, interaction with an application via selection of an icon updates icons of a lower level in the hierarchical structure.

In some embodiments, the smart-phone is configured to recognize a fingerprint of an operator in contact therewith.

Optionally, the smart-phone is configured to be activated by depression of a recognized fingerprint and moving of said fingerprint in a G shape.

Optionally, the smart-phone is configured to be deactivated by depression of a recognized fingerprint and moving of said fingerprint in a reverse G shape.

A second aspect is directed to a method of activating a smart-phone consisting of touching a touch screen of the smart-phone with a finger having a fingerprint recognizable by the smart-phone and dragging the finger in a G shape.

A third aspect is directed to a method of deactivating a smart-phone consisting of touching a touch screen of the smart-phone with a finger having a fingerprint recognizable by the smart-phone and dragging the finger in a reverse G shape.

### DESCRIPTION OF THE FIGURES

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice.

In the accompanying drawings;

FIG. 1 is a functional block diagram illustrating an Internet enabled computerized telecommunication device such as a mobile phone, a personal organizer, etc.

FIG. 2 is a schematic illustration of a smart phone 2, having a screen 4 with icons 110-128 arranged around the screen, and a central area 6 that is free from icons.

FIG. 3 is a schematic illustration of the smart phone of FIG. 2, showing how it may be activated using a finger with a recognizable finger print, dragged in a G shape track.

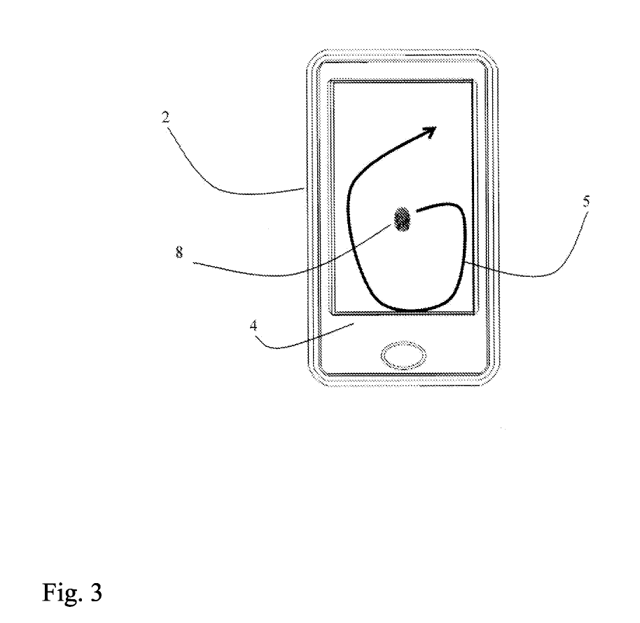

### DESCRIPTION OF THE EMBODIMENTS

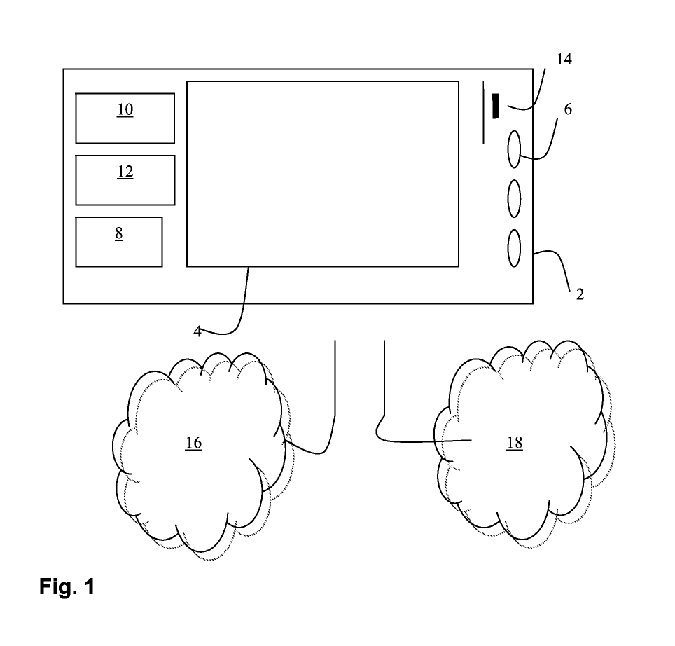

With reference to FIG. 1, a functional block diagram illustrating an Internet enabled computerized telecommunication device 2 such as a mobile phone, a personal organizer, etc. is shown. The computerized telecommunication device 2 is typically but not necessarily handheld. It includes a screen 4 for displaying data to the user. The screen enables graphics and text to be displayed and is a graphical user interface GUI. The device 2 also includes data entry means 6 such as buttons, keys, a joystick, etc. The data entry means enable navigation around the screen 4. In preferred computerized telecommunication devices 2, the screen 4 is a touch screen, enabling both data entry, at least by selection, and display.

The computerized telecommunication device 2 includes at least one processor chip 8, at least one memory for storing data 10, and at least one active memory 12 for storing data that is currently being processed.

The computerized telecommunication device 2 is generally portable and is therefore battery powered, including an internal battery 14. It may, however, be coupled to and powered from a mains supply, or include a solar panel and be solar powered.

The computerized telecommunication device 2 can communicate with other computers and users by accessing a telephone network 16 or a computer network 18, such as the Internet.

Communication generally uses a radio frequency signal, such as Wi-Fi or Bluetooth, to access the Internet. For simple conversation, a lower bandwidth telecommunications network, perhaps including a traditional phone network may be used.

There are a wide range of computerized telecommunication devices 2. These include smart-phones, personal digital assistants, palm top computers, lap-top computers, desk-top computers, Google Glass™ and the like.

The computerized telecommunication device 2 may offer a number of features that may be hard-wired into the computerized telecommunication device 2, or downloaded and stored in the memory 10. Henceforth, such programs are referred to, hereinbelow, as applications.

Some applications store data for the user to access. Other applications enable communication with other devices, either over a phone connection and/or over the Internet.

The current state of the art includes touch screens which enable a user to select an application, to work with it, and then to close it and select a different application. There is minimum interoperability between different applications. One example of interoperability is a contact list that which a user is able to dial or send emails. The contact list may also select and store the phone numbers or email addresses of incoming callers, either automatically or at user's request, together with other information input by the user or transmitted by the incoming caller. The contact list may enable automated dialing or email addressing, working with the telephony application or the email program.

A first aspect of the invention is directed to the interface. In the current state of the art, touch screen phones display a two dimensional rectangular array of icons, each corresponding to a different application. Selecting an icon causes the corresponding application to open over the screen, obscuring the other icons.

Icons may be skeuomorphic or flat. Indeed, an icon may be a simple numbered square or circle. It is appreciated that despite the ongoing debate regarding the need or advisability of real world mimicking versus simplicity, different users think differently and have different preferences. Thus preferred embodiments will allow the user to select skeuomorphic icons or simpler selectable buttons on the screen that may be differentiated by color, shape or by a number, letter or word.

In the present invention, the icons corresponding to the more regularly used functions and applications are arranged around the perimeter of the smart phone, which may be a rectangular device as in current smart phones, but may alternatively have a more organic, natural shape, and be elliptical or round, for example.

The icons are typically arranged in a default order by the service provider. They may be manually rearranged by the operator. Alternatively the mobile phone may be programmed to periodically rearrange so that the icons corresponding to the most regularly used applications are arranged sequentially clockwise or anticlockwise in accordance with the default or with the user's preferences.

By way of non-limited example, for many users, there are two foci of their days. These are often work and home, from example. Thus the top icon 110 may relate to the operator's main occupation, such as work. If the operator is a student, the central top icon may, depending on the age of the operator, relate to college or school, for example. Alternatively again, if the operator is presently job searching, it may relate to job vacancies, for example. Thus the top middle icon relates to the operator's main occupation.

With reference to FIG. 1, a schematic illustration of a smart phone 2, having a screen 4 with icons 110-128 arranged around the screen, and a central area 6 that is free from icons appart from an icon 5, which may be as a stick person or photograph, and represents the operator. Icon 110 represents OCCUPATION, which may be job, job hunting, or college, for example, and icon 120 represents home.

Moving round, typically anticlockwise for right handed operators, and clockwise for left handed operators, but at operator's discretion, and with different defaults in the West where one reads and writes from left to right, and in Arabic or Hebrew speaking countries where one reads from right to left, by way of non-limiting example only, in the following order, icons may relate to the following applications, a scheduler 112, an errand list 114, a social network 116 such as Linked-In™ or Facebook™, to service providers, to a financial management application 118 that may enable payment from the smart phone, access to bank accounts, and the like. The icons may be the same size, or a particular icon offering ‘settings’, for example, may be next to the HOME icon, and may be smaller than the other icons.

The second focus, for example, home 120, is generally positioned bottom center. Moving round to the left and going up in a circle, the icons may relate to the car 22 (next to HOME), social activities 24, entertainment & web 26, shopping 28, food 30, and so on.

To operate, the operator would place his finger on the center and slide a G shape on the touch-screen, from the middle to open the phone. The screen shows the icons around the perimeter, with a central, empty region, for interactions. The central region thus represents the operator himself. Selecting the center region, (you), connects the other applications relating to the displayed icons. The operator may choose to touch drag or to multiple select by pressing, in order, every icon of interest. The applications then open up in the order selected.

One may also open a single application individually by selecting the relevant icon, to enable interaction therewith.

It will be appreciated that the term icon may refer to a graphical symbol indicative of the corresponding application, or to a simple square or circle, or similar, perhaps with an appropriate word labeling the functionality of the corresponding application. The term icon is thus used rather loosely.

Every icon will open up on the screen and present to you the options arranged by icon, defining the categories or options for selecting the desired interaction or activities through the device in the order selected. The device knows when operator is finished (done) by the operator lifting the finger from the screen, or finishing the multiple presses, or by saying the word “DONE” or similar, if using voice activation. As the operator indicates that he/she has finished with an application, the device will immediately open up the next icon requested at the beginning of the session, either inside one of the main applications or by starting a subsequent icon.

After making the next icon selection in the same touch drag or multiple press method, when the user has finished (done) with one icon, the next icon opens up and so forth, until all tasks have been completed. The user may then choose to send\activate\command\done for the device to send the information to the relevant icons or to third parties with the information selected regarding the relevant icon. With every icon that opens up, the user defines who, what and where, regarding who with, what and how he/she wishes to interact through the phone, and who information should be sent to. The operator selects the desired order from start to finish by interaction on the screen. In some embodiments, clicking on the icon associated with an open application serves to close the application again.

In many smart phones, applications are automatically closed as other applications are opened. In the present invention, it is suggested that applications may be opened on top of each other. In contradistinction to prior art smart phones, the smart phone of the present invention has a work surface in the middle of the screen where selected applications are opened on top of each other. Operators may arrange two or more open applications side by side for clearer viewing.

Open applications are programmed to interact. Thus if there is an appointment in the calendar, the navigation application will take as a default that the operator is interested in navigating to the appointment.

Similarly, when visiting a Facebook™ or Linked-In™ record for some entity, the user will be prompted to phone, SMS or email the entity if the entity is a contact whose details are in the user's personal phone list or directory. If, however, the contact is not an entity whose details are in the user's personal phone list or directory, the user will be invited to automatically update the phone list.

In general, the individual applications offer various options and are hierarchically arranged.

### EXAMPLES

For example, selecting the OCCUPATION icon 110 where this is configured to mean work, may cause two alternatives to be displayed:

(i) Meeting and Discussions

(ii) Assignments.

If (i) Meetings & Discussions is selected, various options, such as Office, Conference room, and other (definable by user) are offered.

If assignments are selected, the operator will be offered a choice between past assignments, present assignments and future assignments.

Selecting the Scheduler 112 may open subcategories such as Meeting & Discussions, Tasks, Meals, Recreation Activities (Gym, Yoga, baseball, etc.)

House events, and weddings, conference, and other events may be scheduled here. It is a function of preferred embodiments, that if a subcategory such as recreational activities are scheduled, or tasks are scheduled, then under other relevant applications, such as Errand 114 and Social activities 124, the information is automatically updated. Essentially the different applications are interlinked and update each other.

If the Errand 114 application is selected by clicking on the relevant icon, square, circle, etc., the operator may be offered a choice of: (i) Government & Administration (ii) Repair & Maintenance (iii) Pick ups and collections

Under Government & Administration may be nested, Education, Bills, Post Office/Mail.

Under Repair & Maintenance, may be Car, clothing & wear, etc.

If there are assignments under Pick ups and collections when the user selects a service, food or shopping to be dealt with on the way to home or the workplace, the navigation system will plan his route accordingly so he can go to the desired service or shopping place on the way to work or home and the navigator application will plan the route accordingly. Thus the user does not have to actively program the navigation application. Generally, previous history is recorded so the user will typically be taken to stores he knows.

Under Social Network 116 (people), may be various hierarchical subcategories or groupings, such as Work related (Executive, co-worker/associate, employee) college contacts, high-school contacts, Elementary school contacts, army contacts, (if relevant), Family, close friends, or ‘close friends of brother’ or other category defined by user.

If there is a person that the user selects to meet on the way home from the workplace, the messager informs the person, the scheduler will schedule a meeting and the navigation system will plan his route accordingly, thus the user does not have to separately and actively send a message, schedule a meeting and actively program the navigation application.

An icon for Services 118 may provide details of service providers such as house calls, Repair (car or another defined by user), Health (doctor, dentist, etc.), personal care (salon, barber, manicure, pedicure, etc.), Legal assistance, listing lawyers and the like. Another category may include financial assistance, offering accountant, banker, investment manager, etc., house help, such as cleaners, nanny, babysitter and the like.

If a user selects the Services icon 118 and drags it to occupation 110, the user will be offered occupation related services, such as office cleaner, professional insurance broker, corporate lawyer, etc.

However, if a user selects the Services icon 118 and drags it to home 120, the user will be offered home related services, such as house cleaner, babysitter, home gardener, plumber, house insurance broker, personal lawyer, etc.

Finances 119 may include bank accounts, Investments (portfolios, bonds, etc.), Charity activities including following up on the institutes/foundations that the user donates to.

Home 120 may include subcategories such as Indoor, Outdoor, Garage/Parking, particularly for users operating smart homes whereby lights and appliances may be activated using the smart-phone to control the electronics of the house, and to open garage doors and the like. Such applications exist.

Under Social activities 122, may be found Recreation, gym, synagogue or church, sports, etc. Movies & Theatre, Bar/club, concerts or live music, Recreation—such as poker, sports, lecture, etc, each definable by the user to correspond to his or her lifestyle and interests. House events, and weddings may be scheduled here and the scheduler 112 will be automatically updated.

Under Entertainment & Web 124 may be found music (i-tunes™, YouTube™), video (TV-shows, movies, YouTube™), text based media such as magazines, news, blogs, and the like, books, photos (view and take photos\videos), and an internet browser for navigating the Internet.

Under Shopping 126, may be found groceries, clothing & shoes, electronics, accessories, utilities, furniture and books or magazines.

Under Food 128 will be eating out, groceries, delivery and home cooking. If the user selects eating out, this will be notified to scheduler 112 and user will be offered the option of interacting with people 116 to invite a companion. If the groceries option is selected, the scheduler 112 and shopping 126 applications will be updated accordingly.

With all food options there may be a favorites option. Indeed, every place the user goes to, the user may add to favorites or remove from favorites.

For some users, Occupation 110 will indicate job searching and have subcategories such as upcoming interviews, rejections, approvals, and the like. When unemployed the user can choose to get push notifications when within a user determined radius of places looking to hire appropriate candidates. The smart-phone knows the user's selection details and qualifications, and when he is near a workplace that has posted a suitable vacancy on the internee, it will make the match and notify the user by a push notification.

For some users, Occupation 110 will mean College or high school, and so dragging social network 116 to occupation 110, will open subcategories for administration, professors, teaching assistants and classmates.

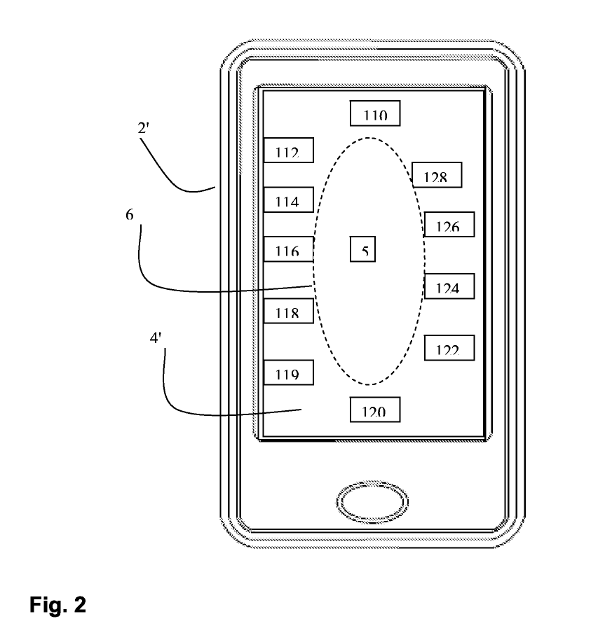

If a schedule related appointment input into the scheduler 112 or an event (social or work related) is to take place overseas or far from home or the place of work, the device will immediately display and open a travel application 130. The box or icon associated with the travel application 130 is not shown in FIG. 2 and will generally not be displayed unless the user travels a lot. Indeed, the user may decide to hide the travel application 130 icon or box, or any other icon or box of an application he does not often use. Such applications, once installed will always be there but may not be displayed unless user scrolls to the side, or such icons may be displayed less brightly on the screen, or otherwise made less visible.

The user may hide or dim any icon, circle or square that is rarely used. Only by actively clicking on such an icon for a longer period, say 2 seconds or so, will it be reactivated.

Typically, applications are constructed in a hierarchical manner such that selection of a first level application such as Travel.

Selecting the Travel icon may open up a range of second level icons, such as: (i) flight, (ii) accommodation, (iii) dietary requirements, (iv) Transportation, etc.

Selecting the flight icon will open a flight application providing options for flying the selected route which may be known to the travel application since it may communicate with scheduler application, and where a meeting is scheduled to take place and with whom.

If the user has a favorites carrier, such as if, for example, user is based in Israel and therefore travels ELAL™ as Israel is a hub for the carrier, and the user finds various services such as Kosher food as standard, is a member of a frequent flyer club or the like, then the flight application may offer departure of choice followed by return choice. The user may, of course, override the choice offered, in which case the device will present to the user options such as to select flight by airline, price, class (economy, tourist, business, first), time of departure and the like. In some embodiments, the application may offer the user the possibility to choose seating, such as near window, near isle, additional legroom, etc.

After selecting flight, the user will be offered to select (ii) accommodation. If there is a Favorites option, the user may choose favorites. In some embodiments, historic choices are offered. Otherwise, the device may offer options for search by price, location, facilities, and the like. Once a hotel, safe catering apartment, or the like is chosen, the user can then select a room from options available and make a reservation.

(iii) Catering. The user may decide to link the accommodation search and the flight carrier to specific catering requirements such as Kosher, Hallal, Vegetarian, Ying-Yang, Organic, etc. or proximity of accommodation to restaurant offering appropriate food.

Once accommodation is selected, providing a central hub, the catering feature focuses on restaurants, catering services and food vendors appropriate to user's requirements and choices in a convenient radius of the accommodation.

(iv) Transportation within the city may use buses, trains, taxis, metro (subway), light railways, trains, and the like, or car rental and even chauffeur services. Selecting an option such as transportation offers the user a third level range of transportation options such as the above, and selecting one of them provides details of routes, timetables, contact details and the like.

The basic concept behind the travel application is to make the smart-phone more user friendly and effective for the traveler, whether tourist or businessman.

Using the above described hierarchical structure, travel arrangements will be easily and intuitively set up after scheduling spot an appointment and, in case of flight delays and the like, the device will access the Internet to update information and notify accommodation and transport services of rescheduling. Similarly, other participants of a meeting may be notified that the user is late due to traffic or other delays and provided with an updated estimated arrival time. Such messages may be sent automatically, or prepared automatically and sent only with user's authorization, and after an opportunity for personalization.

Similarly, the navigation system deployed by the smart-phone, such as a Global Positioning System (satellite navigation), or a road navigation system such as WAYZ will be updated to user's new location to help the user navigate to a bus stop, hotel, subway station, airport exit, and the like, whilst automatically keeping him updated regarding the arrival time of the transportation, and of alternatives such as the next bus, and the like.

Thus, the smart phone of the present invention is more intuitive and user friendly than present generation smart phones and applications commonly used by the operator are interlinked to update each other. Fuzzy logic and neural networks are used to suggest routes and the like, to maximize the operator's efficiency.

The above discussion has focused on smart phones since it is a major application of the technology described herein. This should not, however, be construed as limiting applications of the technology to smart phones, and persons of the art will be able to apply the underlying principles to interfacing with other devices including computers, tablets, lap top computers, personal digital assistants, GPS devices and the like. Furthermore, where dragging over a touch screen with a finger has been described, a cursor could be moved over a screen with a joystick, mouse, tracker ball or other cursor controller. Indeed, voice activation could be sued to open and close and to interface with functions, so the interface may be voice navigated by someone severely handicapped.

Indeed, by voice activation, a heads up display for a fighter pilot or the display interface of Google glasses may be navigated.

It will be appreciated that the number of icons displayed, their type and position, and the relevant applications, are generally user determinable, although the mobile phone operator may provide defaults and occasionally insist on one or two applications.

A second aspect of the invention is a directed to a biometric lock comprising a thumb print comparison and a rotatable movement.

With reference to FIG. 2, the operator is required to scan his thumbprint 8 into the phone 2 where an image thereof is stored. The camera facility of the mobile phone itself may be used for this purpose. Depressing a thumb or finger having a thumbprint or fingerprint 8 that is recognized onto the screen 4 near the center of the screen, and dragging it over the screen 4 in a clockwise G shaped swirling movement 5 is configured to activate the phone 2. Depressing the thumb and dragging it in a reversed G shape swirl or a counterclockwise G shaped swirl is configured to close and lock the interface.

This replaces the 3×3 or 3×4 array that the operator is required to join different nodes of in a preset order that is currently used to unlock i-phones and the like.

Not only is the G shaped swirl 5 more elegant and intuitive, but it will be appreciated that it is more secure in that by biometric comparison, the operator is more certainly identified, since rather than a code being needed, the fingerprint of the operator is required.

Thus persons skilled in the art will appreciate that the present invention is not limited to what has been particularly shown and described hereinabove. Rather the scope of the present invention is defined by the appended claims and includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

1. A smart-phone interface comprising an arrangement of icons for opening applications arranged around perimeter of display screen leaving an empty central workspace.

2. The smart-phone interface of claim 1, wherein the icons are arranged logically.

3. The smart-phone interface of claim 1, wherein said arrangement has two foci, a first focus being occupation and a second focus being home.

4. The smart-phone interface of claim 3, wherein the first focus is positioned at a top of the screen and the second focus is positioned at a bottom of the screen.

5. The smart-phone of interface claim 1 wherein applications are configured to update each other as applicable.

6. The smart-phone of interface claim 1 wherein the icons are selected from the group comprising skeuomorphic icons, flat icons and simple geometric shapes.

7. The smart-phone interface of claim 6 wherein the icons are simple geometric shapes that are differentiated from each other by at least one of the group comprising size, shape or color.

8. The smart-phone interface of claim 6 wherein the icons are simple geometric shapes that are differentiated from each other by a label selected from the group comprising numbers, letters, words and symbols.

9. The smart-phone interface of claim 6 wherein the icons are geometric shapes selected from the group comprising circles, ellipses, squares, rectangles and rectangles with rounded corners.

10. The smart-phone interface of claim 1 wherein selection of at least one icon causes a display of a range of second level icons of a hierarchical structure, and selection of at least one of the second level icons causes display of third level icons.

11. The smart-phone interface of claim 10 wherein interaction with an application via selection of an icon updates icons of same level in the hierarchical structure.

12. The smart-phone interface of claim 10 wherein interaction with an application via selection of an icon updates icons of a lower level in the hierarchical structure.

13. The smart-phone interface of claim 1 configured to recognize a fingerprint of an operator in contact therewith.

14. The smart-phone interface of claim 13 configured to be activated by depression of a recognized fingerprint and moving of said fingerprint in a G shape.

15. The smart-phone interface of claim 13 configured to be deactivated by depression of a recognized fingerprint and moving of said fingerprint in a reverse G shape.

16. A method of activating a smart-phone consisting of touching a touch screen of the smart-phone with a finger having a fingerprint recognizable by the smart-phone and dragging the finger in a G shape.

17. A method of deactivating a smart-phone consisting of touching a touch screen of the smart-phone with a finger having a fingerprint recognizable by the smart-phone and dragging the finger in a reverse G shape.

18. A smart-phone comprising a memory, a processor and a power supply and a touch screen further comprising an operating system comprising an interface comprising an arrangement of icons for opening applications arranged around perimeter of display screen leaving an empty central workspace.

19. A method of activating the smart-phone of claim 18 consisting of touching the touch screen of the smart-phone with a finger having a fingerprint recognizable by the smart-phone and dragging the finger in a G shape.

20. A method of deactivating the smart-phone of claim 18 consisting of touching the touch screen of the smart-phone with a finger having a fingerprint recognizable by the smart-phone and dragging the finger in a reverse G shape.
